(19) United States
(12) Patent Application Publication
(10) Pub. No.: US 2026/0152367 A1
(43) Pub. Date: Jun. 4, 2026

(54) CONTROLLING OF AN ACCESS TO AN ELEVATOR CAR

(71) Applicant: KONE Corporation, Helsinki (FI)

(72) Inventors: Jere Vuorenala, Helsinki (FI); Sanni Siltanen, Helsinki (FI)

(73) Assignee: KONE Corporation, Helsinki (FI)

(21) Appl. No.: 19/458,421

(22) Filed: Jan. 23, 2026

Related U.S. Application Data
(63) Continuation of application No. PCT/EP2023/074431, filed on Sep. 6, 2023.

(51) Int. Cl. B66B 13/14; B66B 13/26

(52) U.S. Cl. CPC B66B 13/146; B66B 13/26; B66B 2201/4638; B66B 2201/4653

(57) ABSTRACT

A method for controlling an access to an elevator car is provided, the method including: receiving a request of an elevator service for a mobile robot, the request including data descriptive of at least one characteristic of the mobile robot; and generating a control signal to cause an opening of the elevator door, the control signal including data defining an opening width of the elevator door in accordance with the data descriptive of at least one characteristic of the mobile robot. Also a computing apparatus, a system and a computer program are provided.

### TECHNICAL FIELD

The invention concerns in general the technical field of elevators. More particularly, the invention concerns controlling of an operation of the elevator.

### BACKGROUND

Mobile robots are more and more integrated to serve humans in various tasks. Co-existence of the mobile robots and humans in various contexts requires arrangements enabling smooth and safe existence of both parties.

One environment bringing the mobile robots and humans on a collision course is different kinds of people conveyor systems residing in premises, such as in buildings. Especially, fitting the passengers together with the mobile robots to elevator cars is a task that requires special attention. For example, due to limited movement capabilities of the mobile robots the elevator system may require an adjustment of an opening time of the elevator door at the landing so that the mobile robot has enough time to enter the elevator car. Another example here is that in some approaches it is required that the humans and the mobile robots do not travel with the same elevator car and this requires sophisticated service allocation by the elevator system.

Generally speaking, the co-existence of the humans and the mobile robots is a field into which it is possible to introduce novel approaches for enhancing a service quality of an elevator system. For example, solutions optimizing loading time of elevator cars as well as safeguarding expected service quality for humans are always required.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present a method, a computing apparatus, a system and a computer program for controlling an access to an elevator car.

The objects of the invention are reached by a method, a computing apparatus, a system and a computer program as defined by the respective independent claims.

According to a first aspect, a method for controlling an access to an elevator car is provided, the method, performed by a computing apparatus), comprises:
receiving a request of an elevator service for a mobile robot, the request comprising data descriptive of at least one characteristic of the mobile robot,
generating a control signal to cause an opening of the elevator door, the control signal comprising data defining an opening width of the elevator door in accordance with the data descriptive of at least one characteristic of the mobile robot.

The at least one characteristic may e.g. be a width of the mobile robot.

The method may further comprise:
controlling a motion speed of the elevator door.

For example, the motion speed of the elevator door may be adjusted based on a travel speed of the mobile robot. The travel speed of the mobile robot may be received from at least one of: the request; from data storage.

The method may further comprise:
generating a control signal to the mobile robot, the control signal comprising data defining a position of the mobile robot in relation to the accessing to the elevator car.

The position may be defined as at least one of the following: a position inside the elevator car blocking the opening width of the elevator door at least in part; a position outside the elevator car blocking the opening with of the elevator car at least in part.

Moreover, the method may further comprise:
generating a control signal to the elevator door in response to a detection that the mobile robot resides in the elevator car, the control signal comprising data causing a closing of the elevator door.

The method may also further comprise in response to a receipt of a request:
generating a control signal preventing the closing of the elevator door.

The request may be received from the mobile robot.

According to a second aspect, a computing apparatus for controlling an access to an elevator car is provided, the computing apparatus is configured to:
receive a request of an elevator service for a mobile robot, the request comprising data descriptive of at least one characteristic of the mobile robot,
generate a control signal to cause an opening of the elevator door, the control signal comprising data defining an opening width of the elevator door in accordance with the data descriptive of at least one characteristic of the mobile robot.

The computing apparatus may e.g. be configured to apply a width of the mobile robot as the at least one characteristic.

The computing apparatus may further be configured to:
control a motion speed of the elevator door.

The computing apparatus may be configured to control the motion speed of the elevator door by adjusting it based on a travel speed of the mobile robot. For example, the computing apparatus may be arranged to receive the travel speed of the mobile robot from at least one of: the request; from data storage.

The computing apparatus may also further be configured to:
generate a control signal to the mobile robot, the control signal comprising data defining a position of the mobile robot in relation to the accessing to the elevator car.

Moreover, the computing apparatus may be configured to define the position as at least one of the following: a position inside the elevator car blocking the opening width of the elevator door at least in part; a position outside the elevator car blocking the opening with of the elevator car at least in part.

Still further, the computing apparatus may further be configured to:
generate a control signal to the elevator door in response to a detection that the mobile robot resides in the elevator car, the control signal comprising data causing a closing of the elevator door.

The computing apparatus may further be configured to in response to a receipt of a request:
generate a control signal preventing the closing of the elevator door.

The request may be received from the mobile robot.

According to a third aspect, a system is provided, the system comprising:
an elevator door,
an elevator car accessible through the elevator door,
a mobile robot, and
a computing apparatus according to the second aspect as defined above.

According to a fourth aspect, a computer program is provided, the computer program comprising instructions to cause the computing apparatus according to the second aspect as defined above to execute the steps of the method according to the first aspect as defined above.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically entities belonging to the application area according to an example.

FIG. 2 illustrates schematically a method according to an example.

FIG. 3 illustrates schematically an implementation according to an example.

FIG. 4 illustrates schematically an apparatus according to an example.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

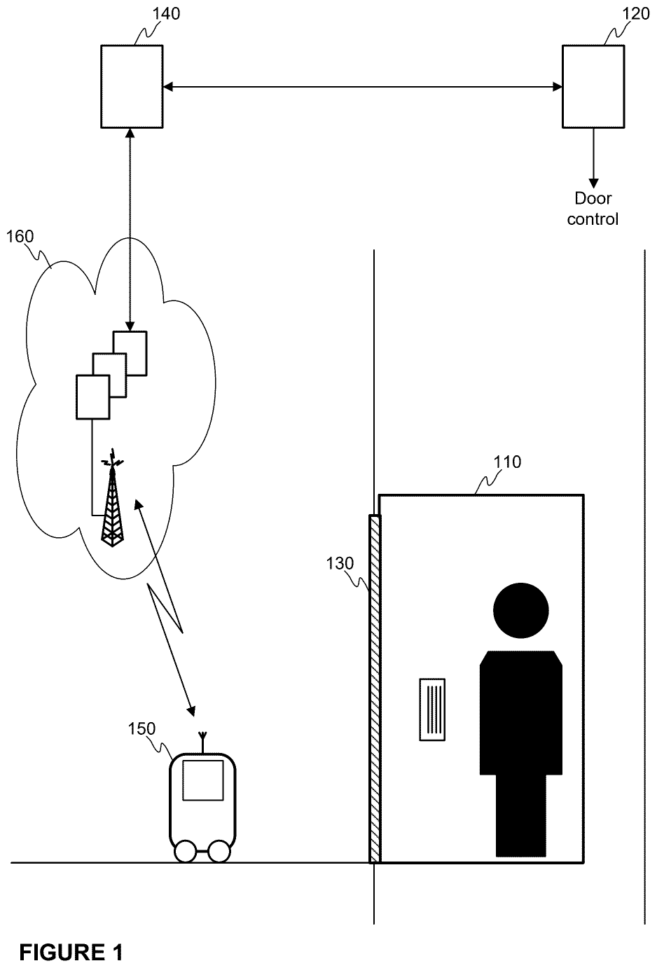

In order to provide insight into an application area of the invention it is hereby referred to FIG. 1. An elevator is present that is configured to operate in certain premises, such as in a building, in a ship and so on. The operation of the elevator comprises serving passengers by carrying them from one floor to another. The elevator is equipped with an elevator 110 and its operation, such as a travel between floors, is controlled from an elevator controller 120. The elevator controller 120 may also control either directly or indirectly an opening of an elevator door 130 wherein the elevator door 130 may consists of an elevator car door or an elevator shaft door or both. The elevator controller 120 may also receive input from various sources, such as from input devices (e.g. from a call giving device) and various sensors from the elevator. In accordance with the present invention the elevator controller 120 may be provided with an interface, such as with an application programming interface (API), to communicate with external entities. In accordance with the present invention the external entity refers to an entity in a robot domain. The non-limiting example as shown in FIG. 1 comprises a robot domain consisting of a robot controller 140 and a number of mobile robots 150. The mobile robots 150 may operate in the same premises as the elevator. The mobile robots 150 and the robot controller 140 are communicatively connected to each other in any known manner, such as over a mobile communication network 160.

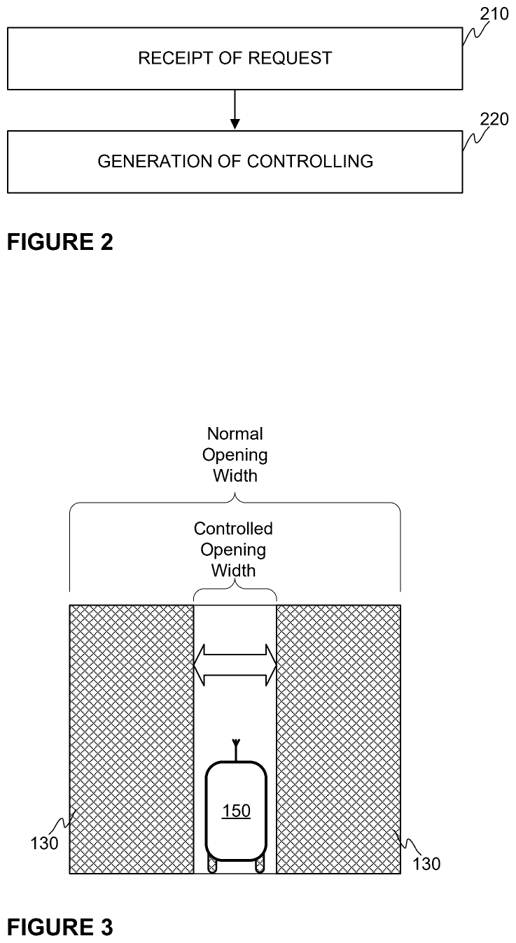

As already discussed, the co-presence of humans and the mobile robots 150 in the same premises and especially as users of the elevator may cause conflicts which may be experienced negative by the humans, but also in terms of overall operability of the elevator system. Therefore, in accordance with the present invention it is introduced a solution to control an access to the elevator car 110. The solution according to an embodiment of the invention is now described as a method by referring to FIG. 2.

First, a controller device considered herein to be the elevator controller 120 receives 210 a request of an elevator service for a mobile robot 150 over a communication channel. The request comprises data descriptive of at least one characteristic of the mobile robot 150. The request may e.g. be received 210 from the robot controller 140. The robot controller 140 may e.g. be aware of a route each robot 150 controlled by the robot controller 140 is instructed to execute as well as of locations of each robot 150. Hence, in response to a detection that a mobile robot 150 in question has entered premises and requires an elevator service in its route the robot controller 140, e.g. based on its location with respect to the elevator, may generate the request to the elevator controller 120. In accordance with another embodiment the mobile robot 150 may monitor its location on its own and operate autonomously or semi-autonomously in response to a receipt of a task to be executed from the robot controller 140. The definition of the task may e.g. comprise a definition of a route with other necessary information that is followed by the mobile robot 150. In the approaches the mobile robot 150 is operating autonomously or semi-autonomously the mobile robot 150 may detect an instant of time, e.g. based on a location with respect to the elevator door 130 in the premises, when a generation of the request of the elevator service is meaningful. The mobile robot 150 may also take other parameters into account in the generation of the request and its timing, such as a crowdedness of the floor or a predefined area at the floor, such as a predefined area in front of the elevator door 130 in the hall. By taking into account one or more criteria as described the mobile robot 150 may be configured to generate a request for elevator service to the robot controller 140 that indicates the service request to the elevator controller 120 in order to generate an elevator call. In some embodiments the mobile robot 150 may also be arranged to communicate directly with the elevator controller 120 without involving the robot controller 140 to that. This may be achieved by arranging an applicable interface, such as a user interface or a communication interface of the elevator in the premises, which may be operated by the mobile robot 150. For example, the user interface may be a button operable by the mobile robot 150 e.g. manually with an applicable arm or similar. The communication interface may be configured to implement a communication technology the mobile robot 150 is equipped with and, thus, to convey the service request as well as other requests to the elevator controller 120. It may also be arranged that the mobile robot 150 is detected in the premises with a detection system that automatically generates the service request under predefined conditions, such as the mobile robot 150 resides in a certain location, that service request leads to the generation of the elevator call. The service request conveyed to the elevator controller 120 e.g. in the manner as described carries at least one piece of data indicative of the floor into which the elevator service is requested to. In other words, the elevator controller 120 receives data based on which it is possible to determine the floor into which the service is requested. The service request also carries data indicative of a destination floor so as to enable the elevator controller 120 to determine the route the elevator car 110 is instructed to travel in order to provide the requested service to the mobile robot 150.

As already mentioned, the service request also comprises data defining at least one characteristic of the mobile robot 150 for which the service is requested to. The at least one characteristic is such that it defines, or based on that it is derivable, at least one predefined parameter in relation to the mobile robot 150, such as in relation to an appearance of the mobile robot 150 or in relation to an operation of the mobile robot 150 or in relation to a door operation required by the mobile robot 150. In accordance with an embodiment of the invention service request comprises a parameter as the at least one characteristic that defines at least a width of the mobile robot 150 in a moving direction of the mobile robot 150. Alternatively or in addition, the parameter as the at least one characteristic may be an identifier of the mobile robot 150, e.g. defining a type of the mobile robot 150, by means of which a controller may inquire the at least one parameter in relation to the mobile robot 150 from data storage arranged to store information on the mobile robot(s) 150 in question.

The respective controller, such as the elevator controller 120, receiving the service request may be communicatively connected either directly or indirectly to such data storage. As a result the elevator controller 120 may acquire and then possess data defining the characteristics of the mobile robot 150 which may e.g. be the width of the mobile robot 150. In an embodiment that all the mobile robots 150 operating in the premises of the elevator are the same type of robots, e.g. having the same appearance (cf. a size in terms of a width in the moving direction of the mobile robot 150), it is enough that the at least one characteristic, or other information in the service call, indicates that the service call is from a mobile robot 150. In this kind of approach the elevator controller 120 may be configured to be aware of the at least one characteristic as described, e.g. by arranging an access to such piece of data stored in an accessible data storage, or as a default value, i.e. defining the width of all the robots 150, for example. Still further, the data in the request descriptive of at least one characteristic of the mobile robot 150 may comprise a definition for a required opening width of the elevator door 130. In other words, the mobile robot 150 may be provided with data descriptive of the opening width of the elevator door 130 which is enough the mobile robot 150 to access the elevator door 130, i.e. the data is descriptive of the at least one characteristic of the mobile robot 150. The corresponding piece of data may be obtained from data storage arranged to store such piece of data e.g. by using the identifier of the mobile robot 150, for example.

In response to that the receipt of the request of the elevator service as described the elevator controller 120 is configured to generate 220 a control signal to cause an opening of the elevator door 130. The control signal is provided with data defining at least one parameter with respect to an opening of the elevator door 130 in accordance with the data descriptive of at least one characteristic of the mobile robot 150. For example, the at least one parameter may e.g. be an opening width of the elevator door 130 defined in a predefined manner. The generation 220 of the control signal may be scheduled in accordance with a status of the elevator. For example, it may be generated immediately to a door controller controlling an operation of the elevator door.

Hence, the door controller is configured to control the door accordingly e.g. in response to that the elevator car 110 arrives the floor in question, i.e. where the mobile robot 150 resides to. Alternatively, the scheduling of the generation 220 of the control signal may be implemented so that the elevator controller 120 generates 220 the control signal as described in response to a receipt of an acknowledgement that the elevator car 110 has arrived at the floor or is about to land there. In other words, in the context of the present invention known mechanisms with respect to scheduling the generation 220 of the control signal may be used.

As mentioned, the control signal is provided with, i.e. carrying, data defining at least one parameter with respect to an opening of the elevator door 130 in accordance with the data descriptive of the at least one characteristic. This corresponds to an approach in which the at least one parameter with respect to the opening of the elevator door 130 is defined to be such that the mobile robot 150 may enter the elevator car 110 through the door opening. In other words, at least one operational factor of the elevator door 130 is adjusted in accordance with the at least one characteristic of the mobile robot 150. For example, the opening width of the elevator door 130 may be defined by the elevator controller 120 that is configured to set it so that it is larger than the width of the mobile robot 150 wherein the width of the mobile robot 150 is defined in the direction of movement and may be received as the at least one characteristic of the mobile robot 150 as described. However, in the implementation where the controlled at least one parameter is the opening width of the elevator door 130 it is typically defined to be less that the normal opening width of the elevator door 130 for the grounds as discussed in the forthcoming description. Naturally, a specific situation may be that the width of the mobile robot 150 is such that the elevator door 130 needs to be opened to its normal opening width but even in this case the opening width is defined based on the at least one characteristic of the mobile robot 150 as described. An example of the approach as described is schematically illustrated in FIG. 3 wherein the illustration is drawn from a hall towards an elevator car 110 wherein the mobile robot 150 is residing in front of the elevator door 130. As shown in FIG. 3 the elevator door 130 has a predefined normal opening width (also considerable as a default opening width), but in accordance with the present invention the executed opening width is adjusted based on the at least one characteristic of the mobile robot 150. The controlling of the opening width as described may e.g. be achieved so that the elevator controller 120 generates the control signal carrying data defining a number of parameters defining at least the opening width of the elevator door 130 and the door controller applies the number of parameters in order to control a door motor to cause an opening of the elevator door 130 accordingly. In other words, in case of that the elevator door 130 is a sliding door, the controlling of the opening of the elevator door 130 causes a sliding of at least one door leaf of the elevator door 130 so that the defined opening width is reached. The arrow in FIG. 3 indicates as a non-limiting example that both door leaves of the sliding door may be controlled to open. For sake of completeness, it is worthwhile to mention that the opening width of the elevator door 130 may be defined as an exact distance expressed in a form suitable to be applied by the door controller or directly by the door motor. Alternatively or in addition, the opening width of the elevator door 130 may be expressed with an opening speed of the elevator door 130 to be applied and with a duration of the opening phase of the elevator door 130. The application of these parameters leads to a desired opening width of the elevator door 130.

In the foregoing description the invention is described by disclosing how the opening width of the elevator door 130 may be controlled in accordance with data descriptive of the at least one characteristic of the mobile robot 150 wherein the at least one characteristic may be at least the width of the mobile robot 150 in the direction of the movement. In some further embodiments, in addition to the controlling of the opening width of the elevator door 130 also other aspects in relation to the operation of the elevator door 130 may be controlled to. For example, the method according to an embodiment of the invention may comprise that a motion speed of the elevator door 130 is controlled. The motion speed of the elevator door 130 may e.g. refer to an opening speed of the elevator door 130, a closing speed of the elevator door 130, or both. In case the motion speed of the elevator door 130 is adjusted it may be performed based on a travel speed of the mobile robot 130. The controller, such as the elevator controller 120, may e.g. receive the information descriptive of the travel speed of the mobile robot 150 in the same request in which the elevator service is requested or alternatively, or even in addition, it may be inquired from a data storage e.g. with an identifier of the mobile robot 150 in the same manner as already discussed in the foregoing description. The controlling of the speed of the elevator door 130 may become relevant especially in a situation when the mobile robot 150 enters the elevator car 110 and the elevator door 130 is controlled to close faster than normally, i.e. the closing speed is configured to be faster than the normal closing speed. This optimizes at least in part the time spent at the floor and its effect to the travel time.

In addition to that the opening width of the elevator door 130 is controlled in any of the described manner as well as the operation speed of the elevator door 130 may be controller also an opening time, i.e. the duration the elevator door 130 is kept open, may be controlled. The control may be arranged by including data defining the duration of the opening time to the control signal or by generating another control signal to release the opening state, i.e. causing a closing of the elevator door 130 opened with the first control signal.

The foregoing description is based on a consideration that the operation of the elevator door 130 is controlled in accordance with the at least one characteristic of the mobile robot 150. In addition to that at least some further aspects of the invention may be related to controlling of an operation of the mobile robot 150. Namely, the elevator controller 120 may be configured to generate a control signal to the mobile robot 150 wherein the control signal comprises data defining a position of the mobile robot 150 in relation to the accessing to the elevator car 110. This corresponds to that the mobile robot 150 the mobile robot 150 may be instructed to reside in one or more positions, i.e. locations in the respective floor, during the service provision. In accordance with an embodiment of the present invention the control signal to the mobile robot 150 may be generated by the elevator controller 120 and delivered to the mobile robot 150 e.g. through the robot controller 140 or directly between the elevator controller 120 and the mobile robot 150 if such a communication channel is available. The definition of the position is established so that the mobile robot 150 may either interpret information on the position and travel to the respective position e.g. by utilizing an indoor positioning technology or any similar. Alternatively or in addition, the mobile robot 150 may be provided with specific instructions to cause the mobile robot 150 to travel to the position wherein the instructions may be dedicated orders to the electric motor causing the mobile robot 150 to move as well as steering commands, for instance.

In terms of a process flow the generation of the control signal defining one or more positions for the mobile robot 150 may be made dependent on other events in the controlling of the access to the elevator car 110. In accordance with a non-limiting example the elevator controller 120 may be configured to, in response to a receipt of the request for the elevator service from the mobile robot 150 in some of the described manners, to generate a service call to the elevator system. It may also be configured to determine an estimate of an instant of time the elevator is capable of providing the service to the mobile robot 150 which may at least comprise an instant of time the elevator car 110 arrives the floor the mobile robot 150 resides. Now, if a delay in providing the service at the respective floor exceeds a predefined limit, the elevator controller 120 may be configured to instruct the mobile robot 150 to a first position which e.g. may be a location where the mobile robot 150 does not block a utilization of the floor are by e.g. humans. On the other hand, if the elevator car 110 may arrive at the floor within a predefined time window, the mobile robot 150 may be instructed to a position in front of the elevator door 130, e.g. as shown in FIG. 3. The position in the latter situation may be selected so that the mobile robot 150 may block other passengers to enter to the elevator car 110 or exit therefrom. In some example embodiments, the definition of the position may also be defined so that it is a chain of consecutive positions wherein the first position in in front of the elevator door 130 as described and a second position resides inside the elevator car 110 so that it is stopped inside the elevator car 110 in front of the elevator door 130 so that it still blocks the way inside the elevator car 110 and outside therefrom. In this regard, the control of the opening width of the elevator door 130 serves the same purpose since the width of the elevator door 130 is adjusted in accordance with the at least one characteristic of the mobile robot 150. In other words, the position of the mobile robot 150 may be defined as at least one of the following: a position inside the elevator car 110 blocking the opening width of the elevator door 130 at least in part; a position outside the elevator car 110 blocking the opening with of the elevator car 110 at least in part. Furthermore, the elevator controller 120 may be configured to generate a control signal to the elevator door 130 in response to a detection that the mobile robot 150 resides in the elevator car 110, the control signal comprising data causing a closing of the elevator door 130. The detection may be based on that the predefined opening time has lapsed, but it may also be based on a detection, e.g. with a sensor arrangement, that the mobile robot 150 has entered the elevator car 110. The sensor arrangement may e.g. reside in the hall or in the elevator car 110, or both. It may e.g. be a camera based solution, but also information disclosing a position of the mobile robot 150 may be utilized.

In some embodiments the mobile robot 150 may be configured to generate another types of control signals than the requests for the elevator service as described in the foregoing description. Namely, the mobile robot 150 may generate a request to the elevator controller 120 in any of the described manner wherein the request comprises data indicative of a request with respect to an operation of the elevator. In accordance with an embodiment of the invention the data may be indicative of that the mobile robot 150 requests further controlling of the elevator door 130 wherein the further controlling may e.g. request that a closing of the elevator door 130 is prevented. Such a situation may e.g. occur if the mobile robot 150 is prevented to enter the elevator car 110 for any reason even if it is instructed to do that. For example, the mobile robot 150 may become blocked by humans, or any other reason, and it requires more time to enter the elevator car 110. The mobile robot 150 may detect such a situation by means of sensors arranged in the mobile robot 150 or in response to a receipt of data from another entities, such as from a sensor arrangement arranged to monitor premises. Alternatively or in addition, the robot controller 140, or even the elevator controller 120, may be provided with an access to such data. Thus, in response to a receipt of a request as described either directly or indirectly from the mobile robot 150 the elevator controller 120 may be configured to generate a control signal preventing the closing of the elevator door 130.

In relation to above described situations the control of the elevator door 130 in the described manner may be made dependent on environmental factors experienced by the mobile robot 150. In other words, the control of the elevator door 130 may be made dependent on a detection of deviating conditions from a reference condition. The data descriptive of the condition may be obtained with the sensors arranged in the mobile robot 150 or from a sensor arrangement arranged in the premises or from both of these. Based on the data it may e.g. be detected if there is some deviation in an expected operation of the elevator door 130, if the elevator car 110 has landed in a manner that the mobile robot 150 cannot access the elevator car 110, if the pathway of the mobile robot 150 to the elevator car 110 comprise blocking elements, such as trash, and/or if human passengers are rushing inside the elevator car 110 without a permission and so on. The aim herein is to confirm that the mobile robot 150 may access the elevator car 110 as planned or if it is decided that the environmental factors may cause risk in accessing the elevator car 110 the access may be canceled. The cancellation may refer to that the mobile robot 150 is instructed to not to initiate a travel to the elevator car 110 or return to an initial position of the travel is already initiated. Alternatively or in addition, the cancellation may comprise a control of the elevator door 130, such as controlling it to close or to open e.g. to its normal opening width. Moreover, the controlling may also comprise that the elevator car 110 is instructed to travel to a predefined floor, such as to the ground floor. The evaluation of the environmental factors may be assigned to a predefined controller, such as to the elevator controller 120, which may be provided with all data descriptive of the environmental factors obtained e.g. in the above-described manner by the mobile robot 150 and or by the sensor arrangement.

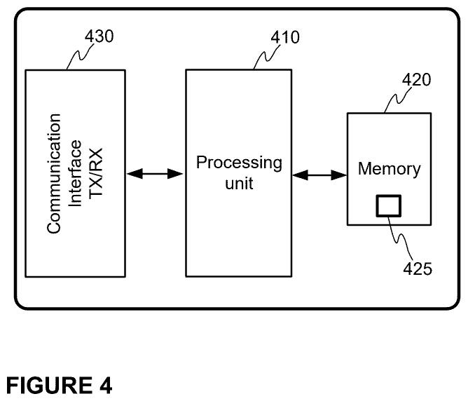

An example of a computing apparatus configurable to implement the operation of a controller, such as the elevator controller 120, is schematically illustrated in FIG. 4. The apparatus may be configured to perform the method according to the invention as described with the examples in the foregoing description. Thus, the apparatus of FIG. 4 may be configured to perform a generation of a control signal for an elevator system. For sake of clarity, it is worthwhile to mention that the block diagram of FIG. 4 depicts some components of an apparatus that may be employed to implement a functionality of the computing entity. The apparatus of FIG. 4 comprises a processor 410 and a memory 420. The memory 420 may store data, such as pieces of data as described, but also computer program code 425 causing the operation in the described manner. In at least some embodiments, the apparatus may further comprise a communication interface 430, such as a wireless communication interface or a communication interface for wired communication, or both to communicate with other entities as described. The communication interface 430 may thus comprise one or more modems, antennas, and any other hardware and software for enabling an execution of the communication e.g. under control of the processor 410. Furthermore, I/O (input/output) components may be arranged, together with the processor 410 and a portion of the computer program code 425, to provide a user interface for receiving input from a user, such as from a technician, and/or providing output to the user of the apparatus when necessary. In particular, the I/O components may include user input means, such as one or more keys or buttons, a keyboard, a touchscreen, or a touchpad, etc. The I/O components may include output means, such as a loudspeaker, a display, or a touchscreen. The components of the apparatus may be communicatively connected to each other via data bus that enables transfer of data and control information between the components.

The memory 420 and at least a portion of the computer program code 425 stored therein may further be arranged, with the processor 410, to cause the apparatus to perform at least a portion of a method as is described herein. The processor 410 may be configured to read from and write to the memory 420. Although the processor 410 is depicted as a respective single component, it may be implemented as respective one or more separate processing components. Similarly, although the memory 420 is depicted as a respective single component, it may be implemented as respective one or more separate components, some, or all of which may be integrated/removable and/or may provide permanent/semi-permanent/dynamic/cached storage.

The computer program code 425 may comprise computer-executable instructions that implement functions that correspond to steps implemented in the method when loaded into the processor 410 of the respective entity. As an example, the computer program code 425 may include a computer program consisting of one or more sequences of one or more instructions. The processor 410 is able to load and execute the computer program by reading the one or more sequences of one or more instructions included therein from the memory 420. The one or more sequences of one or more instructions may be configured to, when executed by the processor 410, cause the apparatus, such as a computer, to perform a method as described. Hence, the apparatus may comprise at least one processor 410 and at least one memory 420 including the computer program code 425 for one or more programs, the at least one memory 420 and the computer program code 425 configured to, with the at least one processor 410, cause the apparatus to perform the method. The computer program code 425, or at least some portion of it, may be provided e.g. a computer program product comprising at least one computer-readable non-transitory medium having the computer program code 425 stored thereon, which computer program code 425, when executed by the processor 410 causes the apparatus to perform the method according to an example. The computer-readable non-transitory medium may comprise a memory device or a record medium, such as a CD-ROM, a DVD, a Blu-ray disc, or another article of manufacture that tangibly embodies the computer program. As another example, the computer program may be provided as a signal configured to reliably transfer the computer program.

Still further, the computer program code 425 may comprise a proprietary application, such as computer program code for causing an execution of the method in the manner as described in the description herein.

Any of the programmed functions mentioned may also be performed in firmware or hardware adapted to or programmed to perform the necessary tasks.

For sake of completeness it is worthwhile to mention that the entity performing the method in the role of the computing entity may also be implemented with a plurality of apparatuses, such as the one schematically illustrated in FIG. 4, as a distributed computing environment. For example, one of the apparatuses may be communicatively connected with the other apparatuses, and e.g. share the data of the method, to cause another apparatus to perform at least one other portion of the method. As a result, the method performed in the distributed computing environment generates the control interface as described. The functionalities of the computing entity as described may also be integrated to an entity configured also to perform other operations.

Generally speaking, the apparatus comprises means for executing the steps of the method in accordance with various embodiments as described herein.

Some aspects of the invention may relate to a system comprising at least an elevator controller 120 and an elevator car 110 accessible through an elevator door 130. The system may also comprise a mobile robot 150 communicatively connected to the elevator controller 120. The system is configured to operate so that the access to the elevator car 110 may be controlled in the described manner.

The specific examples provided in the description given above should not be construed as limiting the applicability and/or the interpretation of the appended claims. Lists and groups of examples provided in the description given above are not exhaustive unless otherwise explicitly stated.

1. A method for controlling an access to an elevator car, the method, performed by a computing apparatus comprises:
receiving a request of an elevator service for a mobile robot, the request comprising data descriptive of at least one characteristic of the mobile robot generating a control signal to cause an opening of the elevator door, the control signal comprising data defining an opening width of the elevator door in accordance with the data descriptive of at least one characteristic of the mobile robot.

2. The method according to claim 1, wherein the at least one characteristic is a width of the mobile robot.

3. The method according to claim 1, the method further comprising:
controlling a motion speed of the elevator door.

4. The method according to claim 3, wherein the motion speed of the elevator door is adjusted based on a travel speed of the mobile robot.

5. The method according to claim 4, wherein the travel speed of the mobile robot is received from at least one of: the request; from data storage.

6. The method according to claim 1, the method further comprises:
generating a control signal to the mobile robot, the control signal comprising data defining a position of the mobile robot in relation to the accessing to the elevator car.

7. The method according to claim 6, wherein the position is defined as at least one of the following: a position inside the elevator car blocking the opening width of the elevator door at least in part; a position outside the elevator car (110) blocking the opening with of the elevator car, at least in part.

8. The method according to claim 1, the method further comprises:
generating a control signal to the elevator door in response to a detection that the mobile robot resides in the elevator car, the control signal comprising data causing a closing of the elevator door.

9. The method according to claim 1, the method further comprises in response to a receipt of a request:
generating a control signal preventing the closing of the elevator door.

10. The method according to claim 9, wherein the request is received from the mobile robot.

11. A computing apparatus for controlling an access to an elevator car, the computing apparatus is configured to:
receive a request of an elevator service for a mobile robot the request comprising data descriptive of at least one characteristic of the mobile robot, generate a control signal to cause an opening of the elevator door, the control signal comprising data defining an opening width of the elevator door in accordance with the data descriptive of at least one characteristic of the mobile robot

12. The computing apparatus according to claim 11, wherein the computing apparatus is configured to apply a width of the mobile robot as the at least one characteristic.

13. The computing apparatus according to claim 11, the computing apparatus further configured to:
control a motion speed of the elevator door.

14. The computing apparatus according to claim 13, wherein the computing apparatus is configured to control the motion speed of the elevator door by adjusting it based on a travel speed of the mobile robot

15. The computing apparatus according to claim 14, wherein the computing apparatus is arranged to receive the travel speed of the mobile robot from at least one of: the request; from data storage.

16. The computing apparatus according to claim 11, the computing apparatus is further configured to:
generate a control signal to the mobile robot, the control signal comprising data defining a position of the mobile robot in relation to the accessing to the elevator car.

17. The computing apparatus according to claim 16, wherein the computing apparatus is configured to define the position as at least one of the following: a position inside the elevator car blocking the opening width of the elevator door at least in part; a position outside the elevator car blocking the opening with of the elevator car at least in part.

18. The computing apparatus according to claim 11, the computing apparatus is further configured to:
generate a control signal to the elevator door in response to a detection that the mobile robot resides in the elevator car, the control signal comprising data causing a closing of the elevator door.

19. The computing apparatus according to claim 11, the computing apparatus further configured to in response to a receipt of a request:
generate a control signal preventing the closing of the elevator door.

20. The computing apparatus according to claim 19, wherein the request is received from the mobile robot.

21. A system, comprising:
an elevator door,
an elevator car accessible through the elevator door,
a mobile robot, and
a computing apparatus according to claim 11.

22. A non-transitory computer readable medium storing a computer program comprising instructions to cause a computing apparatus to execute the steps of the method according claim 1.
